(19) United States
(12) Patent Application Publication
(10) Pub. No.: US 2010/0301645 A1
(43) Pub. Date: Dec. 2, 2010

(54) LIGHTED BABY SEAT CARRIER FOR USE IN PASSENGER VEHICLES

(76) Inventor: Bill Uwnawich, Alhambra, CA (US)

Correspondence Address: Cislo & Thomas LLP, 1333 2nd Street, Suite #500, Santa Monica, CA, 90401-4110, US

(21) Appl. No.: 12/476,694

(22) Filed: Jun. 2, 2009

(51) Int. Cl. B60N 2/28; B60N 2/44

(52) U.S. Cl. 297/183.6

(57) ABSTRACT

A lighted baby seat carrier for infants and small children for use in automotive passenger vehicles is presented. The invention provides an infant or child safety seat having a shell defining cavity for receiving an infant and an arcuate carrying handle attached to opposing sides of the shell. Spaced about the periphery of the carrying handle is a plurality of lights positioned such that the lights illuminate downwardly and light the infant or child's face and torso. The child seat's lighting system also includes a brightness or illumination intensity control such that the intensity of the lights may be adjusted.

### TECHNICAL FIELD

The present invention relates to seats for infants or babies for use in automotive passenger vehicles such as cars, sport utility vehicles and the like. In particular, the invention relates to infant seats that include lights that illuminate the infant when the seat is in use.

### BACKGROUND ART

Concern for the safety of infants and small children riding in automotive vehicles has resulted in the development of numerous devices intended to protect the infant in the case of an accident. While devices such as seatbelts are useful for people of all ages, they have not generally proven adequate for protecting infants or young children. Consequently, child or infant safety seats have been developed to protect and comfortably secure infants and children when they are riding in a vehicle. Early child safety seats were designed to be mounted to the front passenger seat with the child facing forward. This would allow the parent to closely monitor the child while driving by simply glancing over at the child in the passenger seat. When driving at night, the proximity of the child to the parent and the limited illumination coming from a vehicle's dashboard may have proved sufficient to monitor the child, albeit, most parents likely did not consider the limited lighting from the vehicle's dash to be entirely adequate.

More recently, safety concerns regarding the placement of a child seat in the front of a vehicle, and in particular, the risk of injury due to the deployment of front air bags in the event of an accident has mandated that child safety seats be placed in the rear passenger seat of vehicles. The risk to an infant from air bag deployment is believed to be quite significant because adults of modest stature have suffered significant injuries due to air bag deployment forces. Thus, the risk to infants or small children who are generally of very small stature would appear to be concomitantly greater. Placing the infant in the rear seat of a vehicle improves the safety of the child by reducing or eliminating the risk of injury from air bag deployment. However, while likely improving overall safety, placing child safety seats in the rear of a vehicle removes the seat from the easy view of the parent. Parents are now forced to monitor their children either through use of a vehicle's rear view mirror or by taking their eyes fully off the road to turn their heads around to view the child. Since the latter solution to the child monitoring problem may require parents to take their eyes of the road for an inordinate amount of time, it may present an undue risk to both the parent and the child. This is particularly true when driving at night where significantly more time is required to monitor an infant's condition due to typically limited rear seat lighting.

As mentioned, one problem with placing a child safety seat in the rear seat of a vehicle arises from the lack of rear seat illumination when driving at night, i.e. parents cannot effectively monitor the child at night because passenger vehicles typically have little or no rear seat illumination. This problem is compounded when using the vehicle's rear view mirror to monitor the child because, at night, the headlights from vehicles behind the driver tend to wash out what little illumination is available in a vehicle's rear seat and thus objects in the rear seat tend to be not visible or very difficult to see, at best. This, of course, includes rear seat mounted child safety seats and their infant occupants.

Of course, a typical passenger vehicle will have overhead lights that can be turned on by the driver. However, the use of overhead lights by a driver to monitor the back seat region of a vehicle is a less than optimal solution for several reasons. In particular, overhead lighting in a vehicle that would be bright enough to illuminate the rear seat would also likely be bright enough to interfere with the driver's view of the road. In addition the brightness of the overhead lights typically found in passenger vehicles would likely prove sufficient to wake up a sleeping infant or child.

What is needed therefore is a child seat capable of illuminating an infant or child placed in the seat, when the seat is mounted in or on the rear seat of a vehicle. Ideally, it would be desirable to utilize a relatively low intensity light source, such that the light while being bright enough to allow a driver to readily monitor an infant is yet at the same time low enough in intensity so as not to interfere with the driver's vision or to wake a sleeping child. It would also be desirable for the light sources and associated circuitry to be a self-contained part of the infant safety seat itself.

### SUMMARY OF THE INVENTION

The present invention solves the forgoing problems by providing a child safety seat having a shell defining cavity for receiving an infant and a carrying handle attached to opposing sides of the shell. The present invention child seat improves upon the prior art by spacing about the periphery of the carrying handle, a set of lights positioned such that the lights illuminate downwardly from an overhead position and directly light the seat's occupant. The lighting system of the present invention may have a brightness control such that the brightness or intensity of the lights may be adjusted. The lights themselves may be any type of suitable electric light including, but not limited too, incandescent lamps, neon lamps and light emitting diodes (“LEDs”). LEDs are one preferred type of light.

### BRIEF DESCRIPTION OF THE DRAWINGS

FIG. 1 is a front perspective view of one embodiment of the lighted baby seat of the present invention.

FIG. 2 is a front elevational view of the lighted baby seat FIG. 1.

FIG. 3 is a rear elevational view, partially cutaway, of the handle of the lighted baby seat of the present invention.

### DESCRIPTION OF THE PREFERRED EMBODIMENT

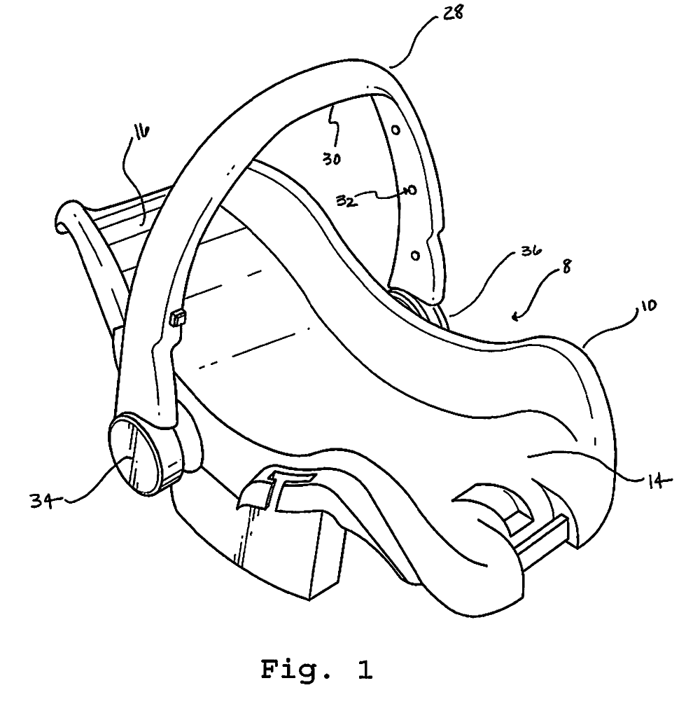

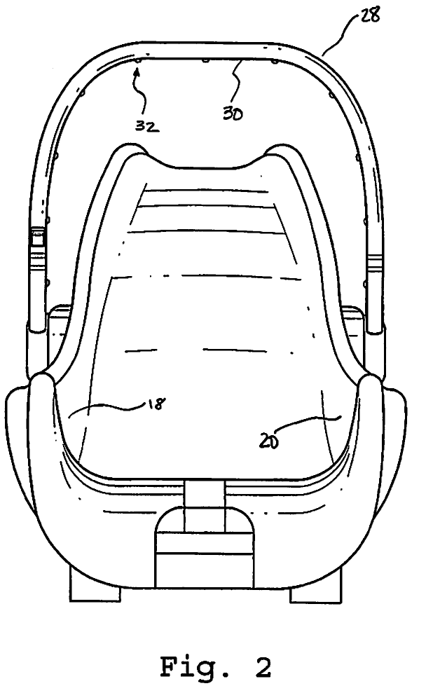

Referring to FIGS. 1-3, the infant seat 8 of the present invention includes a shell 10 which may be formed of a molded plastic material. The inside of the shell may be lined with cushioning material 12 (not shown) which may include a decorative fabric or other covering as is known in the art. The shell 10 comprises a seat portion 14, a back portion 16, and opposing side walls 18 and 20, to form a cavity for receiving an infant. The infant seat is also provided with a carrying handle 28 that is typically U-shaped or oval-shaped, though other shapes are also suitable. The handle includes an inner peripheral surface 30 to which a plurality of lights 32 are attached. The handle is attached to the opposing side walls of the shell at attachment points 34 and 36. The handle may be pivotally, rotatably or rigidly attached to the shell.

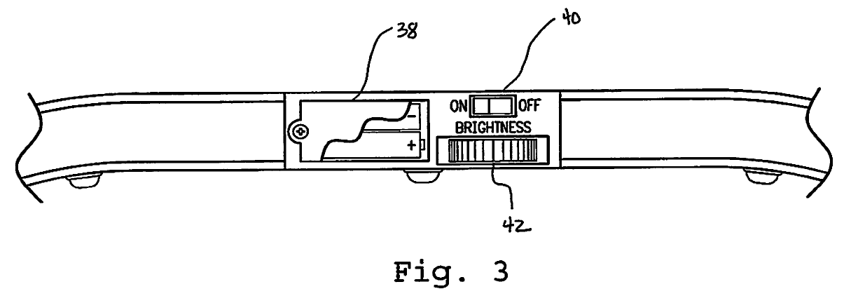

With reference now to FIG. 3, the infant seat 8 of the present invention also includes a power supply 38, a switching means 40, and optionally a brightness control means 42. The power supply, switching means, brightness control means and set of lights are in electrical circuit connection and are integrated with the infant seat 10. Preferably, the power supply, switching means and brightness means are integrated into the handle 28.

The plurality of lights or handle lights 32 is mounted on or imbedded in the peripheral surface 30 of the seat handle 28. These lights are situated so as to direct light downwardly upon the seat occupant. The lights, mounted as they are on the handle, illuminate the seat occupant's face and torso and therefore allow a vehicle's driver to monitor the condition of the seat occupant, i.e. an infant, at night. The plurality of lights outline the handle and seat periphery at night and therefore improve upon prior art infant car seats in that they substantially reduce the risk that a vehicle operator may “fumble” or otherwise mishandle the infant in attempting to remove the seat from the vehicle at night. Likewise, the plurality of lights tends to reduce the chance that an infant's parent may inadvertently toss objects into the vehicle's backseat in the direction of the infant seat and possibly thereby cause injury to the occupant. A further advantage of lighting the seat handle 28 with a plurality of relatively small lights such as LEDs, is improved control over the intensity or brightness of the light given off by the infant seat and directed towards the seat occupant.

The spacing of the plurality of lights 32 will vary depending on the type of lights chosen and their output. With LEDs, a spacing of two inches per light is suitable. However, both a fewer and greater number of lights may be desirable depending the locale in which the seat is used. For example, in city locales which tend to have a substantial amount of ambient light at night to due to a high density of street lights, fewer lights are likely to be required in the infant seat of the present invention. By contrast, in rural locales which may have comparatively little in the way street lighting, a greater number of lights may be desirable in the infant seat of the present invention.

In addition to varying the number of lights used in the present invention infant seat 8, the brightness control means 42 provides for user adjustability of the brightness of the seat's lights. The brightness control means may be a simple variable resister or potentiometer or other such device for varying the current and/or voltage level to the lamps as is known in the art.

The plurality of lights 32 of the present invention may be any type of suitable electric light including, but not limited too, incandescent lamps, neon lamps and light emitting diodes (“LEDs”). LEDs are presently preferred because they consume relatively small amounts of power and provide a soft comfortable light that is comparatively less harsh than that provided by other lamp types. LEDs have the further advantage of generating little heat which makes them suitable for use in seat handle 28 and seat shell 10, which will typically be made of plastic.

Standard household batteries (AAA-cells and the like) are eminently suitable as a source of power for the present invention. Alternatively, the present invention may draw power from a vehicle's electrical system. Multiple connections to a vehicle's electrical system are now readily available in most new passenger cars. For example, most new vehicles are equipped with power ports for the operation of notebook computers and the like. Many cars are also still equipped with conventional cigarette lighters which may serve as sources of power. Power from the aforementioned sources may be readily converted to voltage and amperage levels suitable for use with the electrical circuit of the present invention via power conversion devices readily known to those of skill in the art.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention lighted baby seat carrier, which do not depart from the spirit and scope of the foregoing specification and drawings, and of the claims appended below are possible and practical. It is intended that the claims cover all such modifications and alternative embodiments.

1. An infant seat for use in cars comprising:
a seat shell for receiving an infant;
a seat handle connected to opposing sides of the shell;
a plurality of lights spaced about a periphery of the handle, wherein light from the lights is directed downwardly upon the seat occupant;
an electrical power source for the lights, the power source being in electrical connection with the lights; and
switching means for turning the lights on or off, said means in electrical connection with the lights and power source.

2. The infant seat of claim 1, wherein the plurality of lights spaced about the periphery of the handle direct light downwardly to illuminate the face of the seat occupant.

3. The infant seat of claim 1, wherein the plurality of lights, electrical power source and switching means are integrated with the infant seat.

4. The infant seat of claim 1, further comprising a brightness control means for controlling the brightness of the plurality of lights.

5. The infant seat of claim 1, wherein three lights are spaced about the periphery of the handle.

6. The infant seat of claim 1, wherein the lights spaced about the periphery of the handle are spaced at intervals of two inches.

7. The infant seat of claim 1, wherein the lights are light emitting diodes.
